(19) United States
(12) Patent Application Publication
(10) Pub. No.: US 2013/0297208 A1
(43) Pub. Date: Nov. 7, 2013

(54) Cartography System and Method with Representation by Related Sections

(71) Applicant: Pierre Hayot, Clermont-Ferrand Cedex 9 (FR)

(72) Inventor: Pierre Hayot, Clermont-Ferrand Cedex 9 (FR)

(21) Appl. No.: 13/880,964

(22) PCT Filed: Oct. 20, 2011
(86) PCT No.: PCT/IB11/02495

§ 371 Date: Jul. 25, 2013

(30) Foreign Application Priority Data
Oct. 21, 2010 (FR) 1004167

(51) Int. Cl. G01C 21/34

(52) U.S. Cl. CPC G01C 21/34
USPC 701/533

(57) ABSTRACT

Method for automatically generating route maps, comprising receiving a route to be mapped (101); performing a formatting of the data of the route for arrangement on a support comprising splitting the route (103) to be mapped into a plurality of sections, each section comprising at least one entry point and one exit point; for each section, formatting a corresponding schematic representation of the portion of route in a manner isolated from the corresponding geographical map (104); formatting the sections in such a way that the entry point and/or the exit point of each section is substantially in the same sector with respect to the support on which the sections are arranged (105). Also disclosed is a corresponding system for generating route maps.

### TECHNICAL FIELD OF THE INVENTION

The present invention relates to a method and a system for automatically generating route maps. It relates more particularly to a method making it possible to generate complete and exhaustive route maps, using a restricted memory space.

### PRIOR ART

The devices, method and system for preparing route maps are well known and have even become commonly used tools for a considerably significant number of road users.

For example, document WO2006/042688 describes a method for generating routes indicating, in addition to an optimal route between two given points, the neighbouring points along this route. In addition to the presence of the neighbouring points, which make it possible to facilitate the following of the route by virtue of the tagging of easily viewed points along the track, this document describes a conventional mode of presenting the routes that are prepared before departure, namely a printout on one or more pages comprising written instructions, and one or more pages comprising road maps on which the route established is featured, for example by highlighting. Although this type of tool is useful for preparing a trip, by allowing the driver to take overall cognizance of the forthcoming run, several drawbacks are to be noted during the phase of following the route on the road. For a driver or for a passenger acting in the guise of copilot, the manipulation of several pages for one and the same route sector is very impractical. Moreover, the reading and the understanding of the detailed instructions, without precise relation with the map of the route to be performed, can sometimes be irksome. Finally, precise visual details on the manoeuvres to be performed are in general absent, sometimes causing risks of error in interpreting the instructions. Finally, if such a route, with complete cartographic format must be processed, saved or transmitted to a portable device, the memory capacity, the required power and the required network consumption are relatively significant, and this may restrict the list of compatible apparatuses. The passband consumption imposed on the network gives rise to technical costs both in respect of the device which receives the data and in respect of the system which procures the data. Another restriction originates from the transfer time which likewise becomes excessive because of the technical limitations on network bitrate.

Document FR 2 796 746 describes a system for displaying a route comprising means for generating map information of limited region in the form of a band extending along a route. The width of the band is adapted as a function of the information storage capacity of the device. Such a device does not make it possible, however, to optimize the format of the map since it merely entails undertaking data extraction while preserving the initial format. Moreover, no explanation or instruction is provided to facilitate the following of this route.

Document US2006/0271277 describes a journey or route planning map comprising the display of a route and of elements complementary to this route, such as information relating to hotels, restaurants, tourist sites, etc. These complementary data are beneficial for ensuring the contentment of the passengers of the vehicle, but do not make it possible to facilitate the following of the route as such.

Thus, generally, the existing methods are not very ergonomic and are generally greedy in terms of memory capacity.

To alleviate these various drawbacks, the invention envisages various technical means.

### DISCLOSURE OF THE INVENTION

Firstly, a first object of the invention consists in envisaging a method for generating route maps making it possible to generate route maps occupying reduced or minimized memory space.

Another object of the invention consists in envisaging a method for generating route maps with optimized ergonomics, facilitating understanding and use, in complete safety.

Still another object of the invention consists in envisaging a system for generating route maps occupying a minimum area, but without affecting the clarity or the general quality of the data contained.

Accordingly, the invention envisages a method for automatically generating route maps for system for generating route maps having access to digital road mapping data in conjunction with at least one given geographical zone and making it possible to determine a plurality of maps of routes in this zone, comprising the steps consisting in:
receiving a route to be mapped;
performing a formatting of the data of the route for arrangement on a support comprising the steps consisting in:
   with the aid of a route splitting module, splitting the route to be mapped into a plurality of sections, each section comprising at least one entry point;
   for each section, formatting, with the aid of a module for formatting route elements, a corresponding schematic representation of the portion of route in a manner isolated from the corresponding geographical map;
   formatting the sections in such a way that the entry point of each section is substantially in the same sector with respect to the support on which the sections are arranged.

The fact that the set of entry and/or exit points comprises a neighbouring angular position makes it possible to improve the ergonomics of the route map, by offering the most standard possible format of the manoeuvres. The readability of the map is greatly improved thereby. According to an advantageous example of this embodiment in which the entry points are in the lower portion of the display support (or printing support), this type of implementation allows display of the data in correspondence with a view corresponding substantially to the heading followed by the vehicle, that is to say a view in which the axis of the support is substantially aligned with the axis of the vehicle.

The use of a schematic representation using a few key legs, rather than a suite of maps of the zone covered by the route and parts of this zone, makes it possible to considerably reduce the memory capacity required to store and/or use the maps produced. Thus, a larger number of devices are liable to be able to display the maps generated by the method.

According to another advantageous embodiment, the schematic representation comprises solely the segments identified for achieving the route.

The extraction of the route from the remainder of the cartographic elements confers total freedom of representation of the segments, both from the dimensional and the angular point of view.

According to an advantageous embodiment, the sector with respect to the support on which the sections are arranged is an angular sector. According to various exemplary embodiments, the entry point is in the sector between 165 and 195 degrees, or else in the sector between 345 and 15 degrees, or else is in the sector between 70 and 105 degrees, or else in the sector between 65 and 115 degrees.

According to yet another embodiment, the sector with respect to the support on which the sections are arranged is one of the sides of the section (left, right, bottom, top).

According to yet another embodiment, the sections are unit sections and each unit section comprises an entry point followed by a node corresponding to a manoeuvre to be performed and an exit point.

In an alternative embodiment, the schematic representation comprises in addition segments directly connected to those of the envisaged route. The connected segments concerned are preferably those where manoeuvres are envisaged and those preceding a manoeuvre of crossover type with level crossing.

According to another advantageous embodiment, each section comprises in addition a portion of route with no manoeuvre to be performed. This portion preferably extends substantially up to the following manoeuvre. By virtue of the method according to the invention, this portion is dimensioned as a function of the available area. It is not required to use any additional area, rendering the representation of the route needlessly long.

According to an advantageous embodiment, if these operations cannot be performed in a prior manner or by an external device, the method comprises the steps for detecting the manoeuvres making it possible to perform the route and optionally for obtaining the data of instructions corresponding to the manoeuvres to be performed.

In an advantageous manner, the method moreover comprises a step of arranging the segments of the route so as to afford the schematic representation of the route an orientation substantially along an orientation axis.

In another advantageous embodiment, the distance to be travelled between two instruction points is schematically integrated along the orientation axis for each portion of route. The orientation axis is advantageously represented between the two sides of the support, or else on one of the sides, on the left or right of the support.

In an advantageous manner, the method moreover comprises a step of formatting the schematic representation in which a transformation makes it possible to modify at least one of the characteristics of arrangement of at least part of the segments as a function of the area available for the schematic representation.

The characteristics of arrangement of the segments comprise preferably:
the angles of positioning of the segments with respect to one another;
the profiles of the segments;
the relative lengths of the segments.

The invention also envisages a system for generating route maps for the implementation of the method described above, comprising access to road mapping data in conjunction with at least one given geographical zone and making it possible to determine a plurality of maps of routes in this zone, at least one microprocessor and at least one work memory, a route calculation module, and comprising moreover:
a route splitting module, for splitting the route to be mapped into a plurality of sections;
a module for formatting route elements, for formatting the schematic representation.

According to an advantageous embodiment, the system for generating route maps moreover comprises an analysis module for analyzing the map display support, for determining the area available to display the route map.

According to yet another advantageous embodiment, the system for generating route maps moreover comprises a module for transforming the segments, making it possible to modify characteristics of the segments as a function of the envisaged display format.

According to an advantageous embodiment, the system for generating route maps moreover comprises a manoeuvre detection module, for detecting the manoeuvres to be performed to travel the route.

### DESCRIPTION OF THE FIGURES

All the embodiment details are given in the description which follows, supplemented with FIGS. 1 to 9, presented solely for the purpose of nonlimiting examples, and in which:

FIG. 1A is a schematic representation of a route map generating system according to the invention;

FIG. 1B is a schematic representation of another route map generating system according to the invention;

FIGS. 2A and 2B are schematic representations of the operation of the route map generating system presented in FIG. 1B;

FIG. 3 is another schematic representation of a route map generating system, showing a delocalized work environment;

FIG. 4 is a functional flowchart illustrating the main steps of a route map generating method according to the invention;

FIGS. 5A, 5B and 5C are examples of route maps according to the prior art;

FIG. 6 presents an exemplary route map generated with the aid of a route map generating method and system according to the invention;

FIG. 7 presents another exemplary route map generated with the aid of a route map generating method and system according to the invention;

FIG. 8 presents another exemplary route map generated with the aid of a route map generating method and system according to the invention with the direction of reading of the schematic representations from top to bottom of the support;

FIG. 9 presents another exemplary route map generated with the aid of a route map generating method and system according to the invention in which the splitting of the sections is based on the importance of the road network followed.

### DETAILED DESCRIPTION OF THE INVENTION

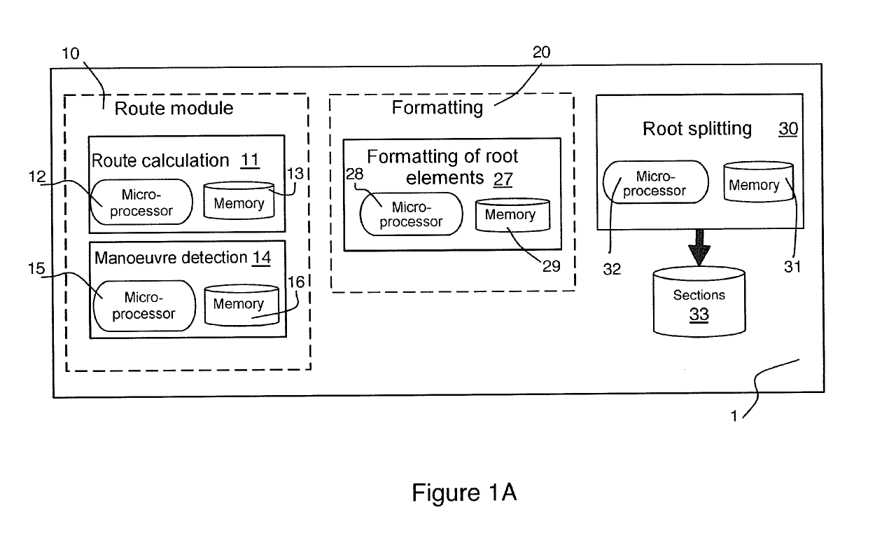

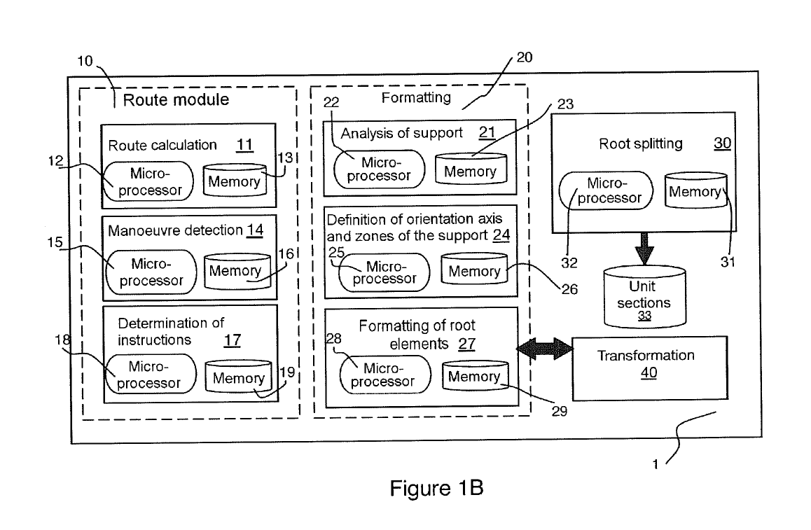

FIG. 1A presents an example of an embodiment of a route map generating system 1. Depicted on the one hand is a route module 10 designed to generate all the data in conjunction with the route for which a map must be produced. The route module 10 comprises a route calculation module 11, provided with calculation means such as a microprocessor 12 and with a work memory 13, a manoeuvre detection module 14, provided with calculation means such as a microprocessor 15 and with a work memory 16. According to various alternative embodiments, the calculation means 12 and 15, just like the work memories 13 and 16, can be centralized for all the modules or the whole of the route map generating system, or else be arranged in an external manner, with connection to the various modules.

The route calculation module 11 operates in a manner known per se, with the aid of an algorithm for determining the shortest path between two points, such as Dijkstra or the like. Such an algorithm makes it possible, with the aid of a microprocessor and of the required instructions, to perform the exploration of a very large number of possibilities, (a few tens or hundreds for zones with low density and/or for short routes with a few hundred thousand, or indeed more, for zones with high density of roads and/or for long routes) with the aim of electing an optimal route as a function of given criteria, such as the shortest route, or the fastest route, etc.

Once the route is known, a manoeuvre detection module 14 makes it possible to detect the manoeuvres to be performed along the route in question. The term manoeuvre is understood to mean mainly an action of driving a vehicle making it possible to select a given leg when the driver is faced with a possibility of committing his vehicle to a plurality of segments (at least two). The driver is faced with multiple possibilities of continuing his course, and a manoeuvre allows him to commit his vehicle as a function of the direction envisaged by the pre-established route. Thus, the module 14 performs a virtual run of the route established by the module 11, and identifies the points or nodes where multiple segments are joined up. This may involve road intersections, exit from or entry to motorways, and forks, etc. The manoeuvres are determined in a manner known per se. For a roundabout, it is understood that a plurality of simple manoeuvres are in general involved, from entry to the roundabout, and then to the crossing of each exit, each time involving a manoeuvre consisting either in remaining in the roundabout or in exiting it, until actual exit from the roundabout. In the present document, roundabouts are considered to be a single manoeuvre, of the type “take the 3^{rd} exit”, in fact consisting in a complex manoeuvre, as mentioned previously.

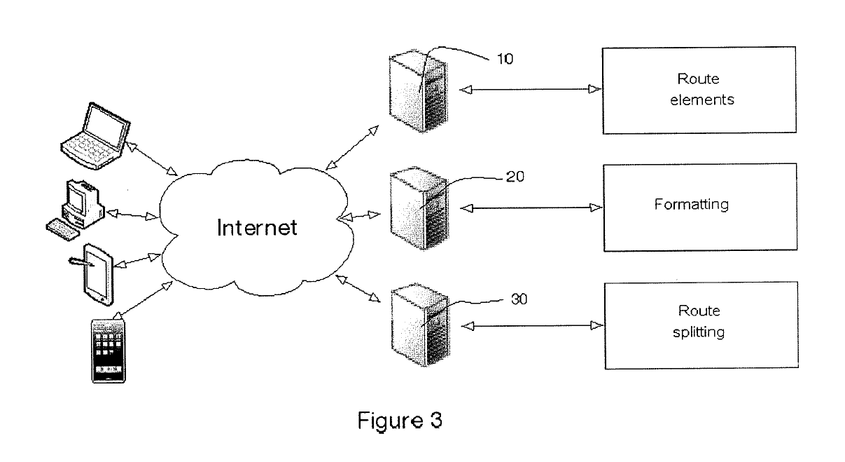

The route module 10 can be envisaged in a manner external to the route map generating system 1, either in proximity to the latter, with direct connection, or remote from the latter, with the connection means of known type such as Wifi, Wimax, by a network, such as the Internet or a cellular telephone network, etc. According to another alternative embodiment, such as shown in FIG. 3, a route module 10 can be common to a plurality of users using remote display devices, of portable type, such as telephones termed “Smartphones”, PDAs, guidance devices of GPS type or the like, laptops or tablet-type computers, etc, or fixed computers, such as a desktop.

According to other alternative embodiments, the route calculation module 11, and/or the manoeuvre detection module 14 are separate or remote, and linked by usual communication or connection means, as mentioned previously. According to yet another alternative, the route calculation modules 11, the manoeuvre detection module 14, can also be combined into a single or two modules.

The formatting block 20 comprises a module for formatting route elements 27, provided with calculation means such as a microprocessor 28 and with a work memory 29. The module for formatting route elements 27 performs the formatting of the elements of routes, in a format suited to the support used.

The formatting module 20 can be envisaged in a manner external to the route map generating system 1, either in proximity the one to the latter, with direct connection, or remote from the latter, with the connection means of known type such as Wifi, Wimax, by a network, such as the Internet or a cellular telephone network, etc. According to another alternative embodiment, such as shown in FIG. 3, a formatting module 20 can be common to a plurality of users using remote display devices, of portable type, such as telephones termed “Smartphones”, PDAs, guidance devices of GPS type or the like, laptops or tablet-type computers, etc, or fixed computers, such as a desktop.

A route splitting module 30 performs a separation of the route to be displayed into a plurality of sections 510. The separation mode and criteria are presented in greater detail further on in this document. The sections generated are stored in a memory or unit for storing sections 33.

The route splitting module 30 can be envisaged in a manner external to the route map generating system 1, either in proximity the one to the latter, with direct connection, or remote from the latter, with the connection means of known type such as Wifi, Wimax, by a network, such as the Internet or a cellular telephone network, etc. According to another alternative embodiment, such as shown in FIG. 3, a route splitting module 30 can be common to a plurality of users using remote display devices, of portable type, such as telephones termed “Smartphones”, PDAs, guidance devices of GPS type or the like, laptops or tablet-type computers, etc, or fixed computers, such as a desktop.

FIG. 1B presents a more complete alternative of the embodiment of the route map generating system described above in conjunction with FIG. 1A.

Depicted therein on the one hand is a route module 10 designed to generate all the data in conjunction with the route for which a map must be produced. The route module 10 comprises a route calculation module 11, provided with calculation means such as a microprocessor 12 and with a work memory 13, a manoeuvre detection module 14, provided with calculation means such as a microprocessor 15 and with a work memory 16, and with an instruction determination module 17, provided with calculation means such as a microprocessor 18 and with a work memory 19. According to various alternative embodiments, the calculation means 12, 15 and 18, just like the work memories 13, 16 and 19, can be centralized for all the modules or the whole of the route map generating system, or else be arranged in an external manner, with connection to the various modules.

The route calculation module 11 operates in a manner known per se, with the aid of an algorithm for determining the shortest path between two points, such as Dijkstra or the like.

Once the route is known, a manoeuvre detection module 14 makes it possible to detect the manoeuvres to be performed along the route in question, as mentioned previously.

The module 17 for determining instructions performs the data associations between the manoeuvres on the one hand, detected by the manoeuvre detection module 14, and the road data of the routes, so as to define instructions in the form of written data, allowing the driver to take cognizance of the usual data such as road names or numbers, the directions to be followed, landmarks, the distances to be travelled, and data relating to the manoeuvres to be performed, such as turn left or right, take the Xth exit, continue straight ahead, etc.

By virtue of the manoeuvre detection module 14 and the module for determining instructions 17, it is possible to obtain data pairs, or paired data, with on the one hand, data relating to a manoeuvre to be displayed in the form of a diagram, and on the other hand of the data relating to the written instructions making it possible to perform the corresponding manoeuvre.

The route module 10 can be envisaged in a manner external to the route map generating system 1, either in proximity to the latter, with direct connection, or remote from the latter, with the connection means of known type such as Wifi, Wimax, by a network, such as the Internet or a cellular telephone network, etc. According to another alternative embodiment, such as shown in FIG. 3, a route module 10 can be common to a plurality of users using remote display devices, of portable type, such as telephones termed “Smartphones”, PDAs, guidance devices of GPS type or the like, laptops or tablet-type computers, etc, or fixed computers, such as a desktop.

According to other alternative embodiments, the route calculation module 11, and/or the manoeuvre detection module 14 and/or the module for determining instructions 17 are separate or remote, and linked by usual communication or connection means, as mentioned previously. According to yet another alternative, the route calculation modules 11, the manoeuvre detection module 14, and the module for determining instructions 17 can also be combined into a single or two modules.

The formatting block 20 comprises a support analysis module 21, provided with calculation means such as a microprocessor 22 and with a work memory 23, a module for defining orientation axis and support zones 24, provided with calculation means such as a microprocessor 25 and with a work memory 26, and with a module for formatting route elements 27, provided with calculation means such as a microprocessor 28 and with a work memory 29. According to various alternative embodiments, the calculation means 22, 25 and 28, just like the work memories 23, 26 and 29, can be centralized for all the modules or the whole of the route map generating system, or else be arranged in an external manner, with connection to the various modules.

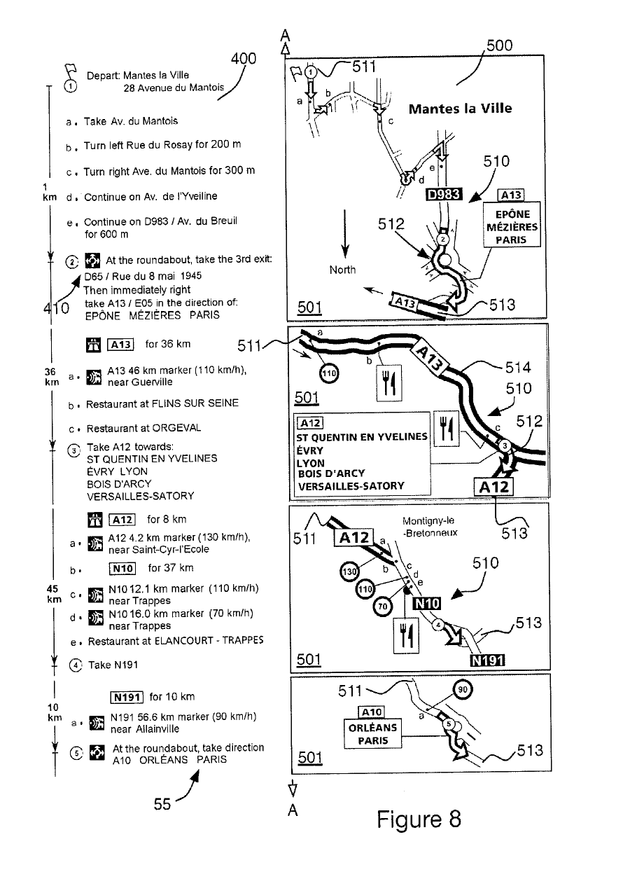

The support analysis module 21 detects the type and the characteristics of display of the support designed for display of the route map, so that the format of the route map can be adapted. As a function of the data gathered by the support analysis module 21, the module for defining axis of orientation and zones of the support 24 defines firstly an orientation axis A-A (FIG. 8), serving to define a preferential direction of orientation on the support, according to which the various manoeuvres of the route will be arranged or aligned. The orientation axis makes it possible to separate two zones 400 and 500 disposed side by side one another. These two zones are designed to contain the paired route elements: on one side 400, the written instructions, and on the other 500, the corresponding manoeuvres. The module for formatting route elements 27 performs the formatting of the paired route elements, in a format suited to the support used and as a function of the orientation axis defined.

The formatting module 20 can be envisaged in a manner external to the route map generating system 1, either in proximity to the latter, with direct connection, or remote from the latter, with the connection means of known type such as Wifi, Wimax, by a network, such as the Internet or a cellular telephone network, etc. According to another alternative embodiment, such as shown in FIG. 3, a formatting module 20 can be common to a plurality of users using remote display devices, of portable type, such as telephones termed “Smartphones”, PDAs, guidance devices of GPS type or the like, laptops or tablet-type computers, etc, or fixed computers, such as a desktop.

A route splitting module 30 performs a separation of the route to be displayed into a plurality of unit sections 510. The separation mode and criteria are presented in greater detail further on in this document. The unit sections generated are stored in a memory or unit for storing unit sections 33.

The route splitting module 30 can be envisaged in a manner external to the route map generating system 1, either in proximity to the latter, with direct connection, or remote from the latter, with the connection means of known type such as Wifi, Wimax, by a network, such as the Internet or a cellular telephone network, etc. According to another alternative embodiment, such as shown in FIG. 3, a route splitting module 30 can be common to a plurality of users using remote display devices, of portable type, such as telephones termed “Smartphones”, PDAs, guidance devices of GPS type or the like, laptops or tablet-type computers, etc, or fixed computers, such as a desktop.

A module for transforming the segments 40, making it possible to modify some of the characteristics of the segments as a function of the display format, is also envisaged. As described further on, this module makes it possible to adapt various characteristics of the segments, such as the shape, the length, the angle, etc, with respect to the adjacent elements, so as to make it possible to reduce the area required to accommodate the schematic representation of the manoeuvre to be performed in a compact manner, without loss of the informative data required to ensure the following of the route. The fact that the manoeuvre displayed is extracted from the road map, and that only a few segments are presented rather than a conventional map, makes it possible to perform adaptations of the shapes without affecting the general arrangement of the map and its readability. The module 40 for transforming the segments is advantageously integrated with or linked to the module for formatting route elements 27.

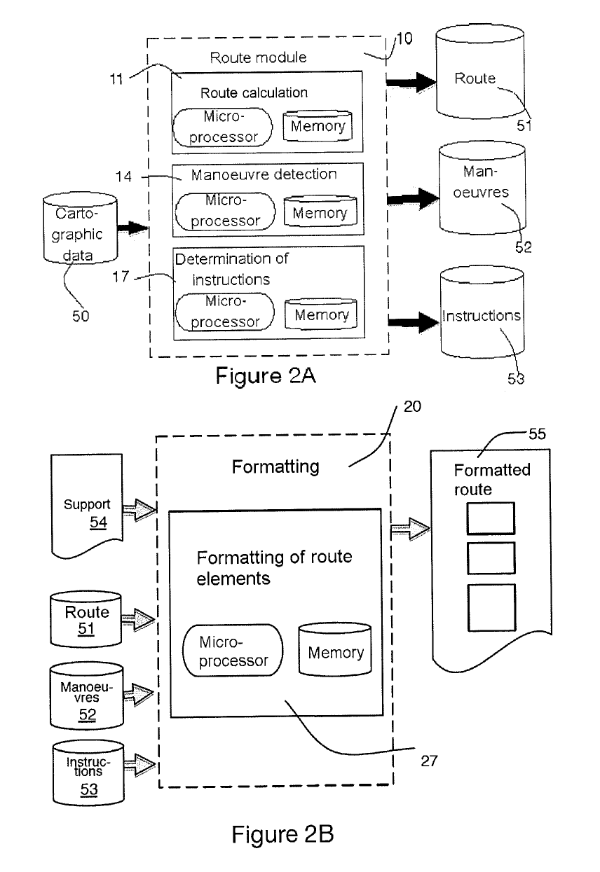

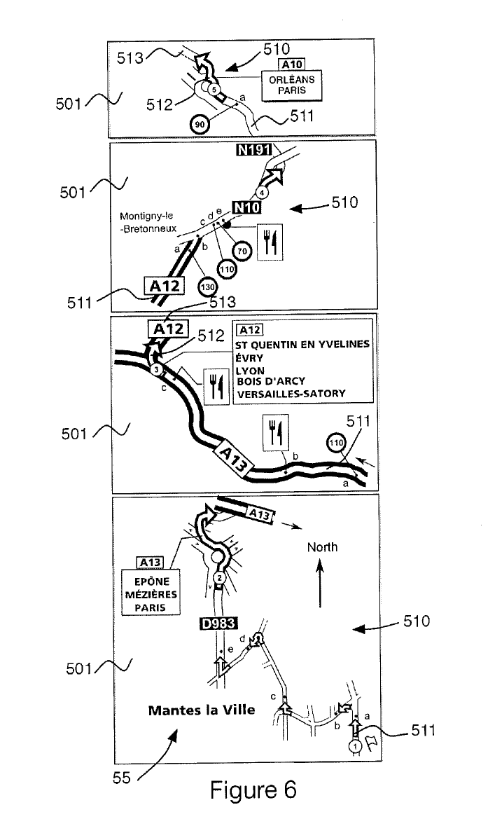

FIGS. 2A and 2B illustrate in a schematic manner the main functions of the route module 10 and of the formatting block 20. In FIG. 2A, it is noted that the raw cartographic data 50 are processed by the route module 10 to obtain the data of the route 51 to be performed, the data of the corresponding manoeuvres 52, and, according to the case, the data of the instructions 53 associated with these manoeuvres. In FIG. 2B is observed the formatting block 20 which, on the basis of the data 54 of the support, of the route 51, of the manoeuvres 52 and optionally of the instructions 53, makes it possible to obtain a formatted route 55, such as presented in greater detail in conjunction with FIGS. 6 to 9.

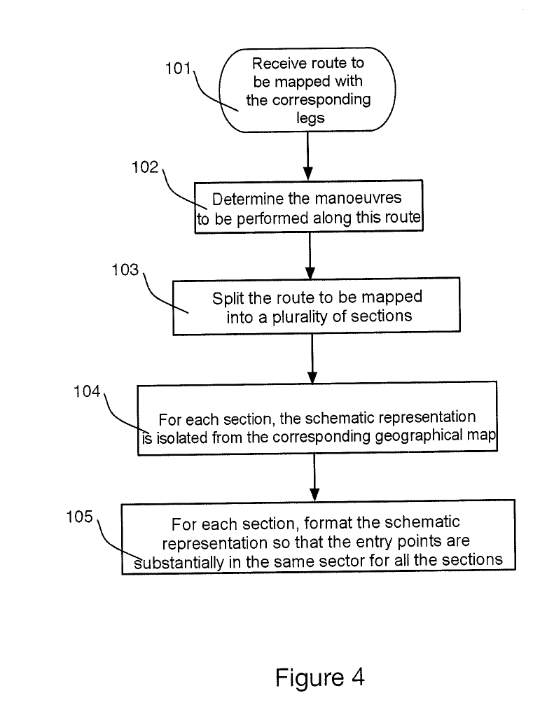

FIG. 4 presents, in a successive manner, the main steps of the method according to the invention. On the one hand, in steps 101 and 102, the data in conjunction with the route 51 are calculated.

In a more detailed manner, in step 101, after reception by a route calculation module 11 of the digital cartographic data of the segments and of the nodes making it possible to reconstruct a representation of the calculated route, the manoeuvres to be performed along the route are determined in step 102 by a manoeuvre determination module 14.

The data in conjunction with the best path to be travelled so as to constitute the route between the departure and arrival points can be calculated prior to step 101 by the route module 10 or by any other route determination device or system. According to an alternative embodiment, they can be calculated by the route module 10 during step 101.

The same holds for the data relating to the manoeuvres 52 which can be obtained prior to the implementation of the method, or in the course of the first steps of the latter.

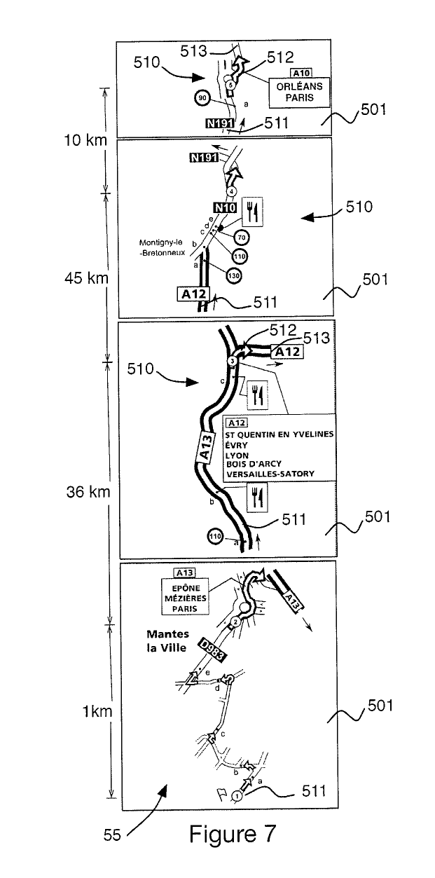

In step 103, the route to be mapped is split into a plurality of sections, by a splitting module 30, and then stored in a memory 33 of split sections. In an advantageous embodiment, the splitting is performed so that each unit section 510 comprises at least one entry point 511, followed by a node 512 corresponding to a manoeuvre to be performed, and an exit point 513, as seen in FIGS. 7 and 8.

In step 104, the schematic representation is extracted from the global route to be performed. The extraction consists in preserving at the minimum the segments identified for achieving the route. The other segments of the road map, the cartographic background, the other data as well as the format of the road map are preferably not represented. The fact of using only the directly useful segments rather than a conventional detailed cartographic representation on which the route is highlighted confers very great flexibility in configuring and formatting the manoeuvre to be displayed. Indeed, it is possible to shorten one or more segments, without modifying the length of other neighbouring or adjacent segments. The changes of length can be performed without taking account of scale constraints, so that certain segments are shortened more or less than others, while other segments may even be lengthened. The modifications may also involve changes of angles of certain segments, and even changes of shapes. The fact that the route is isolated from the corresponding road map frees one from the constraint of compliance with the shapes, angles and dimensions of the segments. The only constraint is the route itself. This implies that it is preferable not to induce crossovers which do not exist, and not to delete the local crossovers perceptible on the terrain.

In an alternative embodiment, the schematic representation of the manoeuvre comprises in addition other segments, for example segments directly connected to those of the envisaged route, or important segments, liable to serve as landmarks or references to facilitate the following of the route. The segments where forthcoming manoeuvres are envisaged are also advantageously represented. Moreover, to facilitate the following of the route, the sections can comprise a portion of route with no manoeuvre to be performed 514 (FIG. 8), downstream and/or upstream of the portion of route of the manoeuvre itself. These portions with no manoeuvre can be represented until the following manoeuvre.

In certain cases, such as for example for representations with substantially large scale for residential zones, zones of streets with no name or with names that are very hard to see from the road when the vehicle performing the route is moving, a plurality of unit sections are combined for representation on a single diagram. This makes it possible to avoid multiplying the number of diagrams of manoeuvres. Moreover, this type of grouping often corresponds to instructions written succinctly in series, of the type “turn left onto street XXX, and then right onto street YYYY”, etc. FIG. 8, described in detail further on, presents an example of such a combination.

In step 105, the schematic representations are formatted in such a way that the entry points are substantially in the same sector for all the sections.

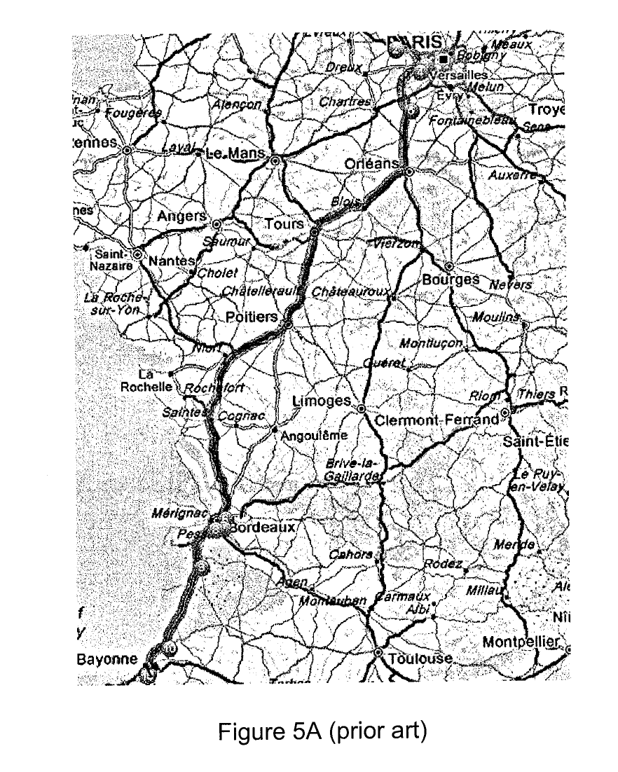

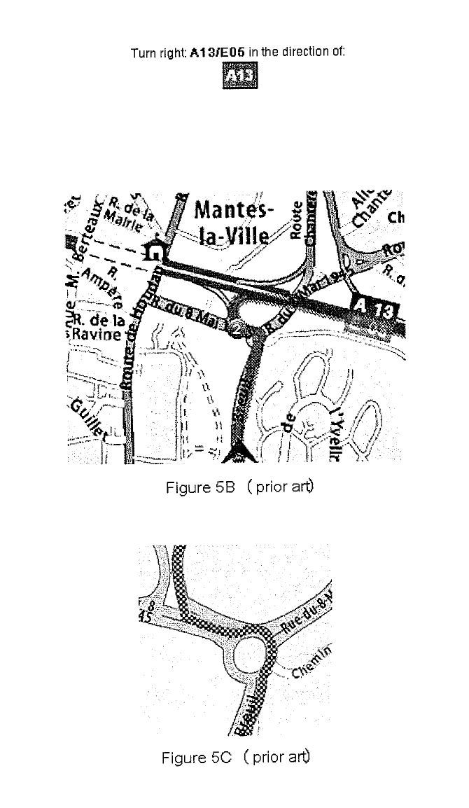

FIG. 5A shows an example of a route map according to the known calculation and display techniques. It is observed that the route to be travelled is indicated by a particular trace applied to the road of the route. This trace is applied to a conventional road map, comprising all the usual details such as place names, and sometimes the numbers of the main roads. In general such a map requires a significant memory capacity and exhibits restricted ergonomics. It is indeed often difficult to clearly distinguish the chosen run from the remainder of the displayed data. Moreover, on account of the use of a map in standardized format, it is not possible to perform modifications of shapes without affecting the nodes and segments situated in the surrounding zone.

FIG. 5B shows an example according to the former technique of displaying a manoeuvre with the corresponding textual data. Here again, the necessary use of the set of detailed maps of this type involves the making available of significant memory capacity.

FIG. 5C illustrates an exemplary detailed display according to the former technique of a manoeuvre, by magnification of the zone where the manoeuvre to be performed is situated.

FIG. 6 presents a first exemplary formatting obtained by virtue of the method described above. Depicted therein is an exemplary route map 55 generated with the aid of the route map generating method and system according to the invention. For each schematic representation 501, the entry point 511 is situated substantially in the same sector, in this example, the lower zone.

In FIG. 7, for each schematic representation 501, the entry point 511 is situated substantially in the same sector, in this example, the lower middle zone. The exit point 513 is also situated advantageously in the same sector, in this example, the opposite corner, i.e. the upper middle zone. A standardized schematic configuration such as this makes it possible to improve the ergonomics and facilitates the reading and the understanding of the manoeuvres to be performed to follow the route flawlessly.

In these two examples (FIGS. 6 and 7), the splitting of the sections is based on the manoeuvres to be performed. This splitting by manoeuvre makes it possible to generate unit sections, preferably comprising a manoeuvre per section, apart from a few exceptional cases, such as for example roundabouts and urban zones. A unit section 510 comprises an entry point 511, a node 512 corresponding to a manoeuvre to be performed, and an exit point 513. For roundabouts, or for certain crossroads, a node may be complex, that is to say comprise multiple possibilities of commitment regarding various segments.

As mentioned previously, the example of FIG. 7 illustrates how simple manoeuvres may be combined on one and the same schematic representation. In this example, the first schematic representation relates to a run of barely a km, such as shown on the left portion of the figure, with the aid of the arrows. Being simple manoeuvres, strung together substantially rapidly, grouping these manoeuvres makes it possible to simplify the schematic representation and especially to avoid multiplying the diagrams for one and the same sector of run.

In the example illustrated in FIG. 7 the direction of reading is envisaged from bottom to top of the support, so as to correspond to a representation of the route with the road in front of the vehicle. Such a representation is very realistic and instinctive and therefore easy to interpret, even with a minimum of data. Moreover, such a type of arrangement corresponds to an increasingly widespread mode, namely the cartographic representation used for devices for mobile guidance of GPS type.

In the alternative presented in FIG. 8, the support is divided into two sections or zones, i.e. a section 400 for the written instructions 410, and a section 500 for the schematic representations 501. The two zones are separated by the axis of orientation of the support A-A. The written instructions 410 are preferably disposed substantially aligned with respect to the corresponding schematic representations. Also in this figure, the schematic representations 501 comprise directions of travel of the vehicle in the same sense as the direction of reading of the data of instructions 410, i.e. from top to bottom. Finally, in this example, the entry point 511 is situated substantially in the same sector for each section, in this example, the top left corner.

The figure also illustrates non-compliance with the cartographic scales, from one diagram to the next. Thus, on substantially comparable support heights are shown initially a run of a km, then subsequently of 36 km, and then of 45 km. This example is aimed at providing the driver with the essential elements for performing the route, without pollution by data not required for following the run.

In the examples of FIGS. 7 and 8, the distances between the manoeuvres are indicated with the aid of arrows in conjunction with the schematic representations 501. These distances are indicated by arrows comprising indications of the number of kms to be travelled between two manoeuvres. Also in the example of FIG. 8, in addition to the written instructions corresponding to the manoeuvres, some informative data, such as for example tourist data, the locations of certain radars, petrol stations, etc, can also be envisaged, for the purposes of convenience of the driver and/or the passengers.

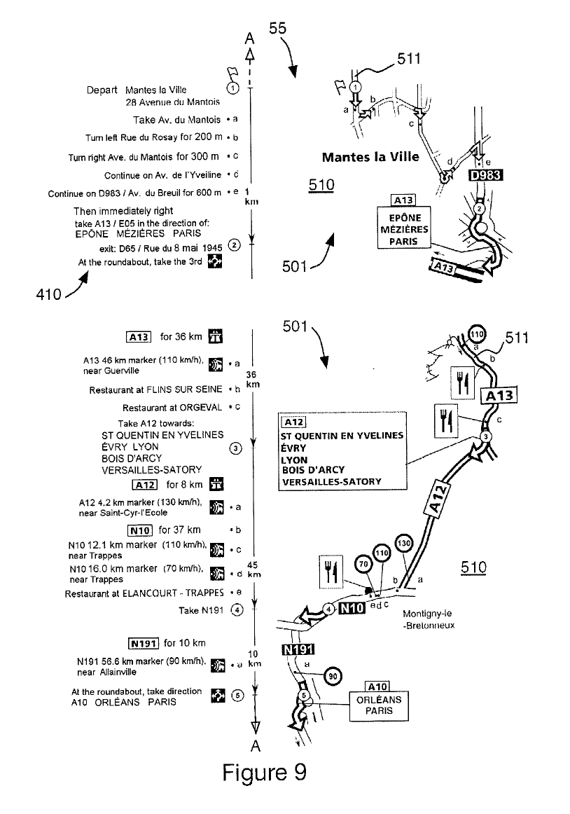

FIG. 9 illustrates another example in which the splitting has been performed as a function of zones within which the route unfolds. In this case, a first zone, substantially urban (Mantes la Ville) has made it possible to delimit a first section 510, and a second zone, substantially interurban (via the motorway A12 and A13, the major roads N10 and N19), has made it possible to delimit a corresponding section 510. It is observed that in the latter section, the importance level of the roads used is in general higher than that of the urban section. The importance level of the roads to be followed can therefore also serve as splitting criterion to establish substantially uniform sections, facilitating the reading and the understanding of the route.

The figures and their descriptions given hereinabove illustrate the invention rather than limiting it. In particular, the invention and its various alternatives have just been described in conjunction with particular examples of splitting based on manoeuvres and on importance levels of the roads followed.

Nonetheless, it is obvious to a person skilled in the art that the invention can be extended to other embodiments in which, as alternatives, a splitting is envisaged as a function of other types of criteria, such as for example as a function of geographical and/or administrative zones, etc,.

The reference signs in the claims do not have any limiting character. The verb “comprise” does not exclude the presence of elements other than those listed in the claims. The word “a” or “an” preceding an element does not exclude the presence of a plurality of such elements.

1. A method for automatically generating route maps for system for generating route maps having access to digital road mapping data in conjunction with at least one given geographical zone and making it possible to determine a plurality of maps of routes in this zone, comprising:
receiving a route to be mapped;
performing a formatting of the data of the route for arrangement on a support comprising the steps of:
with the aid of a route splitting module, splitting the route to be mapped into a plurality of sections, each section comprising at least one entry point;
for each section, formatting, with the aid of a module for formatting route elements, a corresponding schematic representation of the portion of route in a manner isolated from the corresponding geographical map; and
formatting the sections in such a way that the entry point of each section is substantially in the same sector with respect to the support on which the sections are arranged.

2. The method for automatically generating route maps according to claim 1, wherein the sector is an angular sector.

3. The method for automatically generating route maps according to claim 1, wherein the sector is one of the sides of the section.

4. The method for automatically generating route maps according to claim 1, wherein the sections are unit sections and each unit section comprises an entry point followed by a node corresponding to a manoeuvre to be performed and an exit point.

5. The method for automatically generating route maps according to claim 1, further comprising detecting the manoeuvres making it possible to perform the route.

6. The method for automatically generating route maps according to claim 1, comprising a step of formatting the schematic representation in which a transformation makes it possible to modify at least one of the characteristics of arrangement of at least part of the segments as a function of the area available for the schematic representation.

7. The method for automatically generating route maps according to claim 6, wherein the characteristics of arrangement of the segments comprise:
the angles of positioning of the segments with respect to one another;
the profiles of the segments;
the relative lengths of the segments.

8. The method for automatically generating route maps according to claim 7, further comprising a step of arranging the segments of the route so as to afford the schematic representation of the route an orientation substantially along an orientation axis (A-A).

9. A system for generating route maps for the implementation of the method according to claim 1, comprising access to road mapping data in conjunction with at least one given geographical zone and making it possible to determine a plurality of maps of routes in this zone, at least one microprocessor and at least one work memory, a route calculation module, and comprising:
a route splitting module, for splitting the route to be mapped into a plurality of sections; and
a module for formatting route elements, for formatting the schematic representation.

10. The system for generating route maps according to claim 9, further comprising an analysis module for analyzing the map display support, for determining the area available for displaying the route map.

11. The system for generating route maps according to claim 9, further comprising a module for transforming the segments, making it possible to modify characteristics of the segments as a function of the envisaged display format.

12. The system for generating route maps according to claim 9, further comprising a manoeuvre detection module, for detecting the manoeuvres to be performed to travel the route.
